(19) United States
(12) Patent Application Publication
(10) Pub. No.: US 2026/0143276 A1
(43) Pub. Date: May 21, 2026

(54) GAIN MANAGEMENT METHOD AND DEVICE FOR TELEPHONE HEADSET, TELEPHONE HEADSET, AND MEDIUM

(71) Applicant: MERRY ELECTRONICS (SHENZHEN) CO., LTD., ShenZhen (CN)

(72) Inventors: Huaze YANG, ShenZhen (CN); Xuehu WANG, ShenZhen (CN); Tengfei DAI, ShenZhen (CN); Chao NI, ShenZhen (CN)

(21) Appl. No.: 19/053,160

(22) Filed: Feb. 13, 2025

(30) Foreign Application Priority Data
Nov. 19, 2024 (CN) 202411651878.1

(51) Int. Cl. H04R 1/22; H04R 1/08; H04R 1/10

(52) U.S. Cl. CPC H04R 1/222; H04R 1/08; H04R 1/1008

(57) ABSTRACT

Gain management method and device for telephone headset, a telephone headset and a medium are provided. The method includes: detecting a wear state of a headset body of the telephone headset, the headset body being connected to a microphone boom of the telephone headset, a microphone module being provided in the microphone boom; when the wear state of the headset body is a worn state, detecting a first distance from the microphone boom to the head of a human wearing the headset body; when the first distance is within the range of a pre-configured standard distance, maintaining an input gain of the microphone module at a standard gain value; and when the first distance is beyond the standard distance range, adjusting the input gain to a first gain value which is greater than the standard gain value.

### CROSS-REFERENCE TO RELATED APPLICATION

This application claims priority to Chinese Patent Application No. 202411651878.1, filed with CNIPA on Nov. 19, 2024, entitled as “GAIN MANAGEMENT METHOD AND DEVICE FOR TELEPHONE HEADSET, TELEPHONE HEADSET, AND MEDIUM”, the entire contents of which are incorporated herein by reference.

### TECHNICAL FIELD

The present application relates to the field of audio technologies and, in particular, to a gain management method for a telephone headset and a gain management device therefor, a telephone headset, and a medium.

### BACKGROUND

The development of computer technologies has enabled the advent of telephone headsets. The telephone headset may include a headset body and a microphone. The telephone headset is able to be connected to an electronic device by wired or wireless means, and with the telephone headset in combination of communication technologies, two-way voice calls can be achieved. In the prior art, it is generally presupposed that the user can wear the telephone headset in a standard manner, so the input gain of the microphone of the telephone headset is usually fixed.

However, if the user does not wear the telephone headset standardly, sounds received and recorded by the microphone of the telephone headset are of poor quality.

### SUMMARY

In view of the above technical problem, there is a need to provide a gain management method for a telephone headset, a gain management device for the telephone headset, the telephone headset, and a medium, which can improve the quality of recorded sounds.

In a first aspect, the present application provides a gain management method for a telephone headset, including:
detecting a wear state of a headset body of the telephone headset, where the headset body is connected to a microphone boom of the telephone headset, and a microphone module is arranged in the microphone boom;
detecting a first distance from the microphone boom to a head of a human wearing the headset body in a case that the wear state of the headset body is a worn state;
maintaining an input gain of the microphone module at a standard gain value in a case that the first distance is within a pre-configured standard distance range; and
adjusting the input gain to a first gain value in a case that the first distance is beyond the standard distance range, the first gain value being greater than the standard gain value.

In a second aspect, the present application also provides a gain management device for a telephone headset, including:
a first detection module, configured to detect a wear state of a headset body of the telephone headset, where the headset body is connected to a microphone boom of the telephone headset, and a microphone module is arranged in the microphone boom;
a second detection module, configured to detect a first distance from the microphone boom to a head of a human wearing the headset body in a case that the wear state of the headset body is a worn state; and
a gain management module, configured to: maintain an input gain of the microphone module at a standard gain value in a case that the first distance is within a pre-configured standard distance range; and adjust the input gain to a first gain value in a case that the first distance is beyond the standard distance range, the first gain value being greater than the standard gain value.

In a third aspect, the present application also provides a telephone headset, which includes a headset body and a microphone boom, and further includes a wear detection module, a memory and a processor disposed in the headset body, and a distance detection module and a microphone module disposed in the microphone boom, The memory stores a computer program. The wear detection module is configured to detect a wear state of the headset body, the distance detection module is configured to detect a first distance from the microphone boom to a head of a human wearing the headset body, and the microphone module is configured to receive a sound from an environment in which the telephone headset is located and process the sound.

The processor, when executing the computer program, perform the following steps:
detecting the wear state of a headset body of the telephone headset, where the headset body is connected to the microphone boom of the telephone headset, and the microphone module is arranged in the microphone boom;
detecting the first distance from the microphone boom to the head of the human wearing the headset body in a case that the wear state of the headset body is a worn state;
maintaining an input gain of the microphone module at a standard gain value in a case that the first distance is within a pre-configured standard distance range; and
adjusting the input gain to a first gain value in a case that the first distance is beyond the standard distance range, the first gain value being greater than the standard gain value.

In a fourth aspect, the present application also provides a computer-readable storage medium having a computer program stored thereon. The computer program, when executed by a processor, implements the following steps:
detecting a wear state of a headset body of the telephone headset, where the headset body is connected to a microphone boom of the telephone headset, and a microphone module is arranged in the microphone boom;
detecting a first distance from the microphone boom to a head of a human wearing the headset body in a case that the wear state of the headset body is a worn state;
maintaining an input gain of the microphone module at a standard gain value in a case that the first distance is within a pre-configured standard distance range; and
adjusting the input gain to a first gain value in a case that the first distance is beyond the standard distance range, the first gain value being greater than the standard gain value.

In a fifth aspect, the present application also provides a computer program product. The computer program product includes a computer program. The computer program, when executed by a processor, implements the following steps:
detecting a wear state of a headset body of the telephone headset, where the headset body is connected to a microphone boom of the telephone headset, and a microphone module is arranged in the microphone boom;
detecting a first distance from the microphone boom to a head of a human wearing the headset body in a case that the wear state of the headset body is a worn state;
maintaining an input gain of the microphone module at a standard gain value in a case that the first distance is within a pre-configured standard distance range; and
adjusting the input gain to a first gain value in a case that the first distance is beyond the standard distance range, the first gain value being greater than the standard gain value.

In the aforementioned gain management method and gain management device for telephone headset, telephone headset and medium, the headset body of the telephone headset is connected to the microphone boom of the telephone headset, and the microphone module is provided in the microphone boom. In the case that the wear state of the headset body is the worn state, the first distance from the microphone boom to the head of the human wearing the headset body is detected. In the case that the first distance is within the pre-configured standard distance range, it can be determined that the user is wearing the telephone headset in a standard manner, the input gain of the microphone module is maintained at the standard gain value; in this way, the intensity of the sound recorded by the microphone module is in accordance with the standard, and the sound quality is high. In the case that the first distance is beyond the standard distance range, the first distance is shorter than or longer than the standard distance range. When the first distance is shorter than the standard distance range, the head of the human blocks a part of the sound propagation path of the microphone module, resulting in low intensity of the sound received by the microphone module. When the first distance is longer than the standard distance range, the sound propagation path of the microphone module is long, resulting in low intensity of the sound received by the microphone module. In these cases, the input gain is adjusted to the first gain value which is larger than the standard gain value. Hence, the intensity of the sound received by the microphone module can be reasonably increased, and the quality of the sound recorded by the microphone module can be improved.

### BRIEF DESCRIPTION OF THE DRAWINGS

To further clarify technical solutions according to embodiments of the present application or the related technologies, drawings to be used in descriptions of the embodiments of the present application or the related technologies are briefly introduced hereinafter. It is obvious that these drawings described as follows are only for some of the embodiments of the present application, while other related drawings can be obtained by those of ordinary skill in the art based on these drawings without paying creative efforts.

FIG. 1 shows a schematic flowchart of a gain management method for a telephone headset according to an embodiment;

FIG. 2 is a schematic structural diagram of an exemplary telephone headset according to an embodiment;

FIG. 3 schematically shows a relationship between different worn states and the first distance according to an embodiment;

FIG. 4 schematically shows a comparison of frequency response test curves according to an embodiment;

FIG. 5 illustrates schematic process flow of gain management for a telephone headset according to an embodiment;

FIG. 6 schematically illustrates a relationship between values of an input gain and wear states according to an embodiment;

FIG. 7 shows a block diagram of a structure of a gain management device for a telephone headset according to an embodiment; and

FIG. 8 shows an internal structure of a telephone headset according to an embodiment.

### DETAILED DESCRIPTION OF THE EMBODIMENTS

To make the objectives, technical solutions and advantages of the present application clearer and more understandable, the present application is further detailed hereinafter according to embodiments in conjunction with the drawings. It is understandable that specific embodiments described herein are merely for the purpose of explaining the present application rather than limiting the present application.

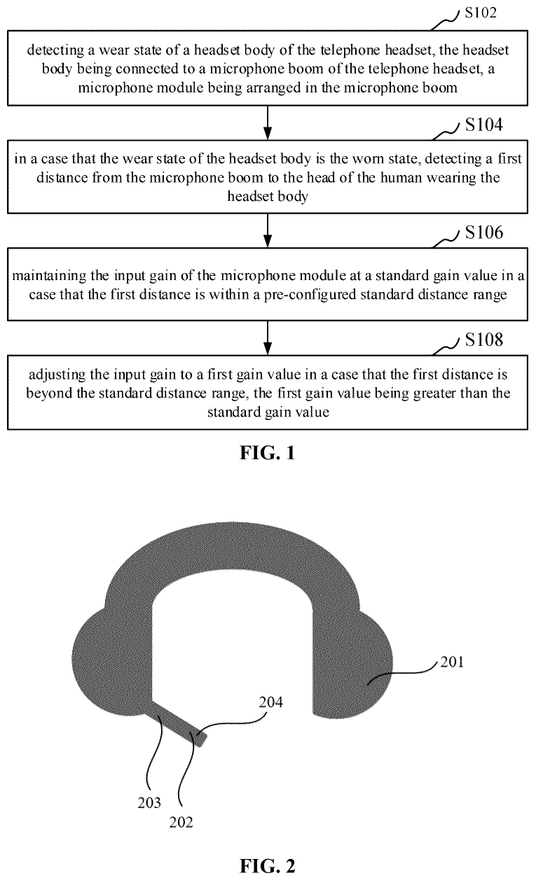

As shown in FIG. 1, a gain management method for a telephone headset is provided in an exemplary embodiment. In the embodiment, it is illustrated by way of example that the method is applied to the telephone headset. According to the embodiment, the method includes the following steps.

Step 102 includes: detecting a wear state of a headset body of the telephone headset. The headset body is connected to a microphone boom of the telephone headset. A microphone module is arranged in the microphone boom.

The telephone headset may be connected to an electronic device having communication function and thus may be utilized to perform voice calls. The electronic device having communication function may be a telephone, a personal computer, a laptop, a smartphone, a tablet, or other. In addition, the telephone headset may be connected to an electronic device having audio amplification function. Sounds received and recorded by the microphone module are then transmitted to the electronic device having audio amplification function, and the sounds are played by the electronic device. The electronic device having audio amplification function may be a loudspeaker with a charging base; specifically, the loudspeaker may be a conference loudspeaker, a vehicle-mounted loudspeaker, or other. In some scenarios, the telephone headset may also be referred to as a telephone communication headset, a telephonist-dedicated headset, a call center headset, or other.

The headset body may be in headband type or supra-aural type. One or two speakers may be provided in the headset body, and the speakers are utilized to play sound. The wear state represents a state how the headset body is worn over the head of a human. The wear state may include a worn state and a non-worn state. A controller may be provided in the headset body. The controller may be utilized to perform the aforementioned gain management method for the telephone headset.

The microphone boom may either be fixedly connected or rotatablely connected to one speaker in the headset body. The microphone module provides a sound pickup function. The sound pickup function includes: receiving a sound from an environment where the telephone headset is located, processing the received sound according to an input gain of the microphone module to record the sound, and transmitting the recorded sound to the electronic device connected to the telephone headset.

Exemplarily, the telephone headset may include a wear detection module provided in the headset body. The controller of the telephone headset may detect, by means of the wear detection module, the wear state of the headset body of the telephone headset.

The wear detection module may be implemented by an infrared sensor, a pressure sensor, or other components. In a case that the wear detection module is implemented by the infrared sensor, the wear state of the headset body can be detected by detecting, by the infrared sensor, whether an emitted signal is blocked or by detecting a distance between the speaker of the headset and the head. In a case that the wear detection module is implemented by the pressure sensor, the wear state of the headset body can be detected by detecting a pressure applied by the headset body onto the head of the human. The wear detection module may be provided at a location of the speaker of the headset body.

According to an embodiment, the controller of the telephone headset may instruct the wear detection module to detect, in real time, the wear state of the headset body of the telephone headset, and may receive feedback from the wear detection module on the wear state of the headset body.

Step 104 includes: in a case that the wear state of the headset body is the worn state, detecting a first distance from the microphone boom to the head of the human wearing the headset body.

Here, the worn state indicates that the headset body has been worn over the head of the human. The first distance may be a distance from a location of the microphone module in the microphone boom to a location of the mouth of the human. The first distance may alternatively be a distance from the location of the microphone module in the microphone boom to a location of the face of the human.

Exemplarily, the telephone headset may include a distance detection module provided in the microphone boom. In the case that the wear state of the headset body is the worn state, the controller of the telephone headset may detect, by means of the distance detection module, the first distance from the microphone boom to the head of the human wearing the headset body.

The distance detection module may be provided at the location of the microphone module in the microphone boom. The distance detection module may be implemented by an infrared sensor, a photoelectric sensor, an ultrasonic sensor, or the like. FIG. 2 schematically illustrates one exemplary structure of the telephone headset. The telephone headset may include a headset body and a microphone boom, and may further include a wear detection module 201, a microphone module, and a distance detection module 204. The microphone module includes a main microphone 202 and a microphone array 203. The headset body, which may be in headband type, includes two speakers. The wear detection module 201 may be disposed at a location of one speaker, and the microphone boom may be connected to the other speaker at a location of a headphone-microphone connection. The main microphone 202, the microphone array 203, and the distance detection module 204 may be disposed in the microphone boom. The main microphone 202 and the distance detection module 204 may be disposed away from the headphone-microphone connection, and the microphone array 203 may be disposed close to the headphone-microphone connection.

According to an embodiment, in the case that the wear state of the headset body is the worn state, the controller of the telephone headset may transmit a distance detection instruction to the distance detection module. The distance detection module, upon receiving the distance detection instruction, detects the first distance from the microphone boom to the head of the human wearing the headset body, and feeds the first distance back to the controller of the telephone headset.

Step 106 includes: maintaining the input gain of the microphone module at a standard gain value in a case that the first distance is within a pre-configured standard distance range.

The pre-configured standard distance range is a range defined by a pre-configured minimum standard distance and a pre-configured maximum standard distance. The minimum standard distance is the minimum value of the standard distance range, and the maximum standard distance is the maximum value of the standard distance range. The standard distance range can be obtained from actual tests on the telephone headset. Otherwise, the standard distance range can be obtained by an engineer according to the product shape of the telephone headset, combined with engineering experience. Distinct telephone headsets can correspond to different standard distance ranges. Specifically, the standard distance range can be from 1 centimeter to 1.5 centimeters.

The input gain is utilized to adjust the intensity of the sound received by the microphone module. The input gain may represent the degree of amplification of the sound. It is understandable that good auditory effect can be achieved by adjusting the intensity of the received sound into a suitable range. The intensity of the sound may specifically be the amplitude of a sound signal. The amplitude of the sound signal may be directly proportional to the volume of the sound, i.e., the greater the amplitude of the sound signal, the greater the volume of the sound. In some scenarios, the input gain may be referred to as Gain. The standard gain value may be pre-configured. The standard gain value can be obtained through actual tests on the telephone headset. The standard gain value can alternatively be set by the engineer according to engineering experience. The standard gain value may be, for example, 6.

In obtaining the standard gain value and the standard distance range through actual tests, the headset body may be worn by a real person or over a simulated human head; a generated sound is kept unchanged, different combination values for the input gain and the first distance are set, and amplitudes of sounds received, processed and then outputted by the microphone module under different combination values are measured. Then, the standard gain value and standard distance range can be determined according to the combination values that enable the amplitudes to be within a standard amplitude range. As can be understood, the standard amplitude range is a range that enables acoustic comfort for human ears, and can be set based on experience.

Exemplarily, the input gain of the microphone module may be set to the standard gain value by default. The controller of the telephone headset may maintain the input gain of the microphone module at the standard gain value upon determining that the first distance is within the pre-configured standard distance range.

According to an embodiment, at least one microphone may be included in the microphone module. The input gain of the microphone module is an input gain of the at least one microphone. The at least one microphone is utilized to receive a sound and transmit the sound after sound processing to an electronic device connected to the telephone headset. The input gain is utilized to adjust the intensity of the sound received by the at least one microphone. In the specification, the microphone module may include only one microphone, or may include multiple microphones. It is understandable that when the microphone module includes multiple microphones, the input gain is utilized to adjust intensities of sound(s) received by the multiple microphones. The sound processing may include at least a step of adjusting the intensity of the received sound according to the input gain, and may also include a step of converting an analog signal of the sound into a digital signal, a step of signal denoising, or other steps.

According to an embodiment, the microphone module may include a main microphone and a microphone array. The input gain of the microphone module is an input gain of the main microphone. The main microphone is utilized to receive a sound and transmit the sound after sound processing to the electronic device connected to the telephone headset. The input gain is utilized to adjust the intensity of the sound received by the main microphone.

Step 108 includes: adjusting the input gain to a first gain value in a case that the first distance is beyond the standard distance range, the first gain value being greater than the standard gain value.

Being beyond the standard distance range may be being less than the minimum value of the standard distance range or being greater than the maximum value of the standard distance range. The first gain value may be pre-configured. The first gain value may be obtained through actual tests on the telephone headset, or may be set by the engineer based on engineering experience. The first gain value may specifically be 8.

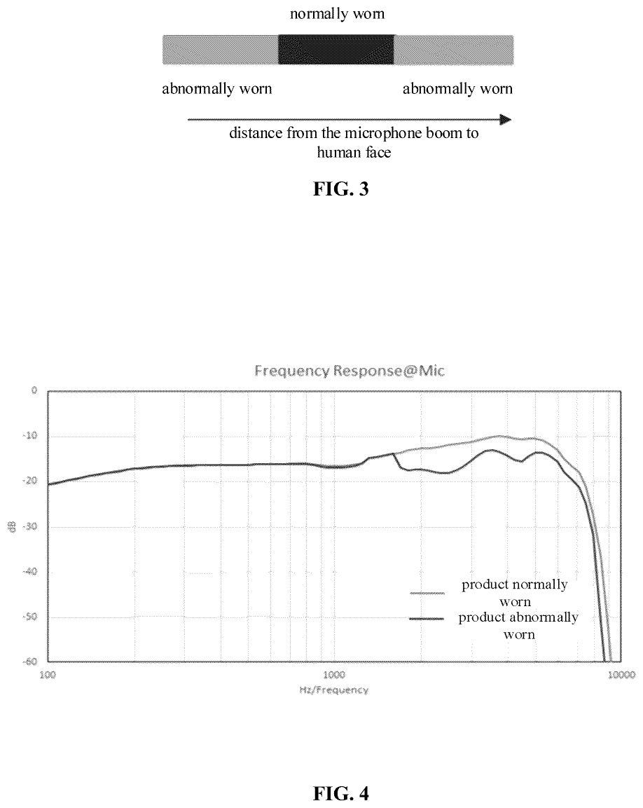

The worn state may include a normal worn state and an abnormal worn state. If the first distance is within the standard distance range, the headset body is in the normal worn state, and if the first distance is beyond the standard distance range, the headset body is in the abnormal worn state. FIG. 3 schematically illustrates the relationship between different worn states, i.e., the normal worn state and the abnormal worn state, and the first distance. The first distance may be the distance from the microphone boom to the face of the human wearing the headset body. For example, when the first distance ranges from 1 centimeter to 1.5 centimeters, the headset body is normally worn, and when the first distance is less than 1 centimeter or greater than 1.5 centimeters, the headset body is abnormally worn.

If the human has a big head, a situation where the first distance is less than the minimum value of the standard distance range may occur, indicating that the microphone boom is too close to the head of the human wearing the headset body. In this situation, the head of the human may block part of a sound propagation path of the microphone module, resulting in low intensity of the sound received by the microphone module. If the first distance is greater than the maximum value of the standard distance range, it indicates that the microphone boom is too far from the head of the human wearing the headset body. In this situation, the sound propagation path is relatively long, resulting in low intensity of the sound received by the microphone module. In addition, if the voice of the human wearing the headset body is small itself, the intensity of the sound received by the microphone module will be very low. It can be seen that in the case where the first distance is beyond the standard distance range, if the received sound is still processed according to the standard gain value, the sound recorded by the microphone module shall be of relatively low intensity, leading to poor sound quality; and after the sound is transmitted to the electronic device for playback, relatively poor auditory sensation will be caused.

Exemplarily, the controller of the telephone headset may reset the input gain of the microphone module to the standard gain value when the telephone headset is powered on. In the case that the first distance is determined to be beyond the pre-configured standard distance range, the controller of the telephone headset may adjust the input gain of the microphone module from the standard gain value to the first gain value.

According to an embodiment, upon determining that the first distance is beyond the pre-configured standard distance range, the controller of the telephone headset may adjust the input gain of the microphone module from a current gain value to the first gain value. The current gain value may be the standard gain value or a gain value after a previous adjustment.

In the above-mentioned gain management method for the telephone headset, the headset body of the telephone headset is connected to the microphone boom of the telephone headset, and the microphone module is provided in the microphone boom. In the case that the wear state of the headset body is the worn state, the first distance from the microphone boom to the head of the human wearing the headset body is detected. In the case that the first distance is within the pre-configured standard distance range, it can be determined that the user is wearing the telephone headset in a standard manner, and then the input gain of the microphone module is maintained at the standard gain value. In this way, the intensity of the sound recorded by the microphone module meets the standard, and the sound quality is high. In the case that the first distance is beyond the standard distance range, the first distance is shorter or longer than the standard distance range. When the first distance is shorter than the standard distance range, the head of the human blocks a part of the sound propagation path of the microphone module, resulting in low intensity of the sound received by the microphone module. When the first distance is longer than the standard distance range, the sound propagation path of the microphone module is long, resulting in low intensity of the sound received by the microphone module. In these cases, the input gain is adjusted to the first gain value which is larger than the standard gain value. Hence, the intensity of the sound received by the microphone module can be reasonably increased, and the quality of the sound recorded by the microphone module can be improved.

According to an exemplary embodiment, after step 102, the aforementioned gain management method for the telephone headset further includes steps of: in a case that the wear state of the headset body is the non-worn state, detecting a second distance from a sound source in the environment to the microphone boom, determining a target gain value matching the second distance, and adjusting the input gain to the target gain value.

The non-worn state indicates that the headset body is not worn. The sound source in the environment refers to a human or an object in the environment that makes sound, which may specifically be a person who speaks. The second distance may be a distance from the sound source to the location of the microphone module in the microphone boom.

Compared with the case where the person who speaks wears the telephone headset, in the case that the wear state of the headset body is the non-worn state, the microphone boom is farther from the person who speaks. If the received sound is still processed according to the standard gain value, the sound recorded by the microphone module shall be of low intensity, leading to poor sound quality; and after the sound is transmitted to the electronic device for playback, relatively poor auditory sensation will be caused.

For example, in a conference scenario, the telephone headset can be wiredly or wirelessly connected to a conference loudspeaker with a charging base, and the person who speaks does not need to wear the telephone headset, and the pickup function is still provided by the microphone module of the telephone headset. In this scenario, the microphone boom is farther to the person who speaks compared to the situation where the person who speaks wears the telephone headset.

In the embodiment, in the case that the wear state of the headset body is the non-worn state, by detecting the second distance from the sound source in the environment to the microphone boom, and then determining the target gain value matching the second distance and adjusting the input gain to the target gain value, the problem of low intensity of the received sound when the headset body is not worn can be prevented to a certain extent, and thus the quality of the recorded sound can be improved.

According to an exemplary embodiment, after step 102, the aforementioned gain management method for telephone headset may further include a step of adjusting the input gain to a second gain value in a case that the headset body is in the non-worn state. The second gain value is greater than the first gain value. The second gain value may be obtained through actual tests on the telephone headset, or may be obtained by the engineer based on engineering experience. For example, the second gain value may be 15. In the embodiment, in the case that the headset body is in the non-worn state, the input gain is directly adjusted to the second gain value, and since the second gain value is greater than the first gain value, the input gain can be quickly adjusted to a relatively reasonable value.

According to an exemplary embodiment, the microphone module includes a microphone array and a main microphone. The input gain of the microphone module is an input gain of the main microphone. The input gain is utilized to adjust the intensity of a sound received by the main microphone. The main microphone is utilized to receive the sound and output the sound after sound processing. The step of detecting the second distance from the sound source in the environment to the microphone boom includes: receiving a sound from the environment by each of multiple microphones included in the microphone array; determining the second distance from the sound source to the microphone boom based on differences in time when every two of the multiple microphones receive the sound.

The microphone module may include the microphone array and the main microphone, the microphone array may be utilized to measure the second distance from the sound source to the microphone boom, and the main microphone may provide a sound pickup function. Outputting the sound after sound processing can be understood as transmitting a signal after sound processing to the electronic device connected to the telephone headset. The sound processing may at least include a step of adjusting the intensity of the received sound according to the input gain, and may also include a step of converting an analog signal of the sound to a digital signal, a step of signal denoising, or other steps.

The microphone array may include multiple microphones, the multiple microphones may be three microphones or more than three microphones. The multiple microphones are provided at different locations in the microphone boom. The time difference means a difference in arrival times of the sound propagated from the sound source to different microphones in the multiple microphones. In some scenarios, the time difference may also be referred to as a time delay.

In the embodiment, the microphone module includes the microphone array and the main microphone. The main microphone is utilized to receive the sound and output the sound after sound processing. Based on the differences in time when every two of the multiple microphones in the microphone array receive the sound, the second distance from the sound source to the microphone boom is determined. Hence, the distance from the sound source to the microphone boom can be measured without affecting the work of the main microphone. With the second distance measured, a target gain value matching the second distance can be determined subsequently.

According to an embodiment, the step of determining the second distance from the sound source to the microphone boom based on differences in time when every two of the multiple microphones receive the sound may include: determining, by the controller of the telephone headset, the second distance from the sound source to the microphone boom through utilizing a pre-configured algorithm based on the differences in time when every two of the multiple microphones receive the sound. The pre-configured algorithm may be Beamforming, Time Difference of Arrival (TDOA), or other.

In an exemplary embodiment, the step of determining the target gain value matching the second distance may include: obtaining a value taken for the second distance, and a pre-configured standard sound source distance value; in a case that the value taken for the second distance is not greater than the standard sound source distance value, determining the standard gain value as the target gain value matching the second distance.

The second distance is the distance from the sound source to the microphone boom. The second distance can be interpreted as a variable, and the value taken for the second distance refers to the value of the second distance. The standard sound source distance value may be obtained through actual tests on the telephone headset, or may be obtained by the engineer based on engineering experience. The standard sound source distance value may be a value within the standard distance range, such as the minimum or maximum value of the standard distance range. It is understandable that in actual scenarios, the person who speaks, when not wearing the headset body, may appropriately speak more loudly than wearing the headset body; consequently, the standard sound source distance value may be larger than the maximum value of the standard distance range. The standard sound source distance value may specifically be 1 centimeter, 10 centimeters, or other.

In the embodiment, in the case that the value taken for the second distance is not greater than the pre-configured standard sound source distance value, which means the distance from the sound source to the microphone boom is reasonable, the standard gain value is determined as the target gain value matching the second distance. In this way, the intensity of the sound recorded by the microphone can be within a reasonable range, and the quality of the sound can be high.

In an exemplary embodiment, the step of determining the target gain value matching the second distance may further include: in a case that the value taken for the second distance is greater than the standard sound source distance value, determining a sound pressure level (SPL) change amount of the value taken for the second distance with respect to the standard sound source distance value, the SPL change amount represents the degree of change in the SPL of the sound received by the microphone module when the value of the second distance is changed from the standard sound source distance value to the value taken for the second distance; determining a gain change amount matching the SPL change amount; and increasing the standard gain value according to the gain change amount to obtain the target gain value matching the second distance.

The SPL change amount may be an amount of change in the SPL of the sound received by the microphone module from a case where the value of the second distance is the standard sound source distance to a case where the value of the second distance is the value taken for the second distance. It is understandable that the sound received by the microphone module is produced by the sound source, and that the second distance is a distance from the sound source to the microphone boom in which the microphone module is located.

SPL is a physical measure of sound pressure. SPL can be measured in decibels (dB). In the case that the value taken for the second distance is greater than the standard sound source distance value, the sound pressure of the sound received by the microphone module can be inversely proportional to the second distance. That is, the greater the distance from the microphone boom to the sound source, the lower the sound pressure of the sound received by the microphone module from the sound source.

An equation about the sound pressure and the second distance can be: p0/p1=x1/x0. Here, p0 represents the sound pressure corresponding to the case that the second distance is the standard sound source distance value, p1 represents the sound pressure corresponding to the case that the second distance is the value taken for the second distance, x1 represents the value taken for the second distance, and x0 represents the standard sound source distance value.

The relationship between the SPL change amount and the gain change amount may be pre-configured. For example, a ratio of the SPL change amount to n may be set as the gain change amount, n being a positive integer greater than 1, e.g., 2, 3, or other. Specifically, in a case that n is set to 3, if the SPL change amount is 6 dB, the gain change amount is 2. If the ratio of the SPL change amount to n is a decimal number, an integer portion of the decimal number may be taken as the gain change amount. Increasing the standard gain value according to the gain change amount may be achieved by adding the gain change amount to the standard gain value.

In the embodiment, when the value taken for the second distance is greater than the standard sound source distance value, that is to say, when the sound source is far from the microphone boom, the SPL change amount of the value taken for the second distance with respect to the standard sound source distance value is determined, the gain change amount matching the SPL change amount is determined, and the standard gain value is increased according to the gain change amount to obtain the target gain value. In this way, low intensity of the sound received by the microphone module far away from the sound source can be compensated for. The sound can be then adjusted according to the target gain value to have an appropriate intensity, and the quality of the sound recorded by the microphone module can be improved.

According to an embodiment, the step of determining the SPL change amount of the value taken for the second distance with respect to the standard sound source distance value may include: determining, by the controller of the telephone headset, a ratio of the value taken for the second distance to the standard sound source distance value, and substituting the ratio into 20*log₁₀(k) to obtain the SPL change amount of value taken for the second distance with respect to the standard sound source distance value.

According to the relational equation of p0/p1=x1/x0, it can be understood that if the ratio of the value taken for the second distance to the standard source distance value is 10, i.e., x1 is 10 times larger than x0, then p1 is 10 times smaller than p 0. That means, the sound pressure is reduced by 10 times when the second distance is changed from the standard source distance value to the value taken for the second distance. Here, log₁₀(k) represents a logarithm of k with a base of 10. The ratio can be substituted as the value of k. 20*log₁₀(k) means multiplying 20 and log₁₀(k). For example, the value taken for the second distance can be 1 meter and the standard sound source distance can be 10 centimeters, so the ratio is 10 and the value of 20*log₁₀(k) is 20; therefore, the SPL change amount is 20.

In an exemplary embodiment, the step of determining the target gain value matching the second distance may further include: determining, from multiple predetermined sound source distance ranges, a predetermined sound source distance range in which the second distance is located, the multiple predetermined sound source distance ranges having a one-to-one correspondence with multiple predetermined gain values; and determining the predetermined gain value corresponding to the predetermined sound source distance range in which the second distance is located as the target gain value matching the second distance.

The predetermined sound source distance range is a sound source distance range that is predetermined. Multiple predetermined sound source distance ranges may include: a range shorter than or equal to 1 meter, a range from 1 meter to 2 meters, a range from 2 meters to 5 meters, and a range equal to or longer than 5 meters, and corresponding predetermined gain values may be 10, 12, 14, and 16, respectively. For example, when the second distance is 1.5 meters, the predetermined sound source distance range in which the second distance is located is the range from 1 meter to 2 meters, and the target gain value matching the second distance is 12. Among the above-mentioned exemplary predetermined sound source distance ranges, the range shorter than or equal to 1 meter may be replaced by a range from 1.5 centimeters to 1 meter, or a range from 10 centimeters to 1 meter.

In an exemplary embodiment, step 108 further includes: detecting a frequency of the sound received by the microphone module in the case that the first distance is beyond the standard distance range; and adjusting the input gain to the first gain value in a case that the frequency is within a first frequency range.

The first frequency range can be obtained through actual tests on the telephone headset, or may be set by the engineer based on engineering experience. When conducting actual tests, a frequency response curve when the first distance is within the standard distance range (that is, the headset body is normally worn) and a frequency response curve when the first distance is beyond the standard distance range (that is, the headset body is abnormally worn) can be tested. The first frequency range can be determined based on a frequency range where there is a difference in response between the two curves.

For example, reference can be made to FIG. 4, which schematically illustrates comparison between frequency response test curves. FIG. 4 depicts a frequency response test curve in a case that the product (telephone headset) is normally worn, and a frequency response test curve in a case that the product is abnormally worn. Compared with the frequency response test curve in the case that the product is normally worn, the frequency response test curve in the case that the product is abnormally worn, with the frequency from 1.5 kHz (1500 Hz) to 8 kHz (8000 Hz), is reduced by about 3 dB to 5 dB. It can be seen that in the case of the product is abnormally worn, the effect in recording mid-high frequency sounds may be adversely affected. The full frequency band can be divided into four bands, including from 100 Hz to 1 kHz (1000 Hz), from 1 kHz to 2 kHz (2000 Hz), from 2 kHz to 5 kHz (5000 Hz), and from 5 kHz to 8 kHz (8000 Hz). Based on the frequency band division and the test result shown in FIG. 4, it is possible to set the first frequency range to be from 1 kHz to 8 kHz, and in the case that the frequency of the sound is in the range from 1 kHz to 8 kHz, the input gain can be adjusted to the first gain value.

A second frequency range below the first frequency range may also be provided. The input gain of the microphone module is maintained at the standard gain value in a case that the frequency of the sound is within the second frequency range. The second frequency range may be from 100 Hz to 1 kHz.

In the embodiment, in the case that the first distance is beyond the standard distance range, if the frequency of the sound received by the microphone is within the first frequency range, the input gain is adjusted to the first gain value. Hence, sound signals are controlled finely, which further improves the quality of the sound recorded by the microphone module.

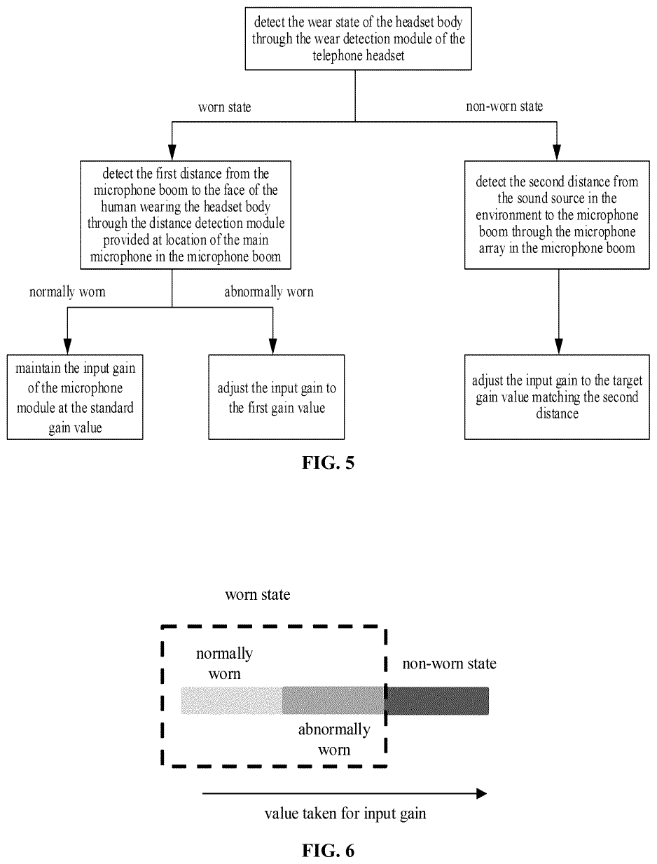

In a specific application scenario, for the telephone headset as shown in FIG. 2, schematic process flow of gain management for the telephone headset can be shown in FIG. 5. A gain management method for the telephone headset may specifically include the following steps.

A controller of the telephone headset may detect, through a wear detection module of the telephone headset, a wear state of a headset body of the telephone headset.

In a case that the wear state of the headset body is a worn state, the controller of the telephone headset may detect, through a distance detection module, a first distance from a microphone boom to the head of a human wearing the headset body.

In a case that the first distance is within a pre-configured standard distance range (which can be understood that the headset body is normally worn), the controller of the telephone headset may maintain an input gain of the microphone module at a standard gain value. The standard gain value may be 6.

In a case that the first distance is beyond the standard distance range (which can be understood that the headset body is abnormally worn), the input gain is adjusted to a first gain value. The first gain value is greater than the standard gain value. The first gain value may be 8.

In a case that the wear state of the headset body is a non-worn state, the controller of the telephone headset may adjust the input gain to a second gain value. The second gain value is greater than the first gain value. The second gain value may specifically be 15. Alternatively, in the case that the wear state of the headset body is the non-worn state, the controller of the telephone headset may determine a second distance from a sound source to the microphone boom through utilizing Beamforming algorithm based on differences in time when every two of multiple microphones of a microphone array receive a sound; and then determine a target gain value matching the second distance, and adjust the input gain to the target gain value.

The target gain value matching the second distance may be determined as follows. A value taken for the second distance and a pre-configured standard sound source distance value are obtained. In a case that the value taken is greater than the standard sound source distance value, a sound pressure level (SPL) change amount of the value taken with respect to the standard sound source distance value is determined. A gain change amount matching the SPL change amount is determined. The standard gain value is increased according to the gain change amount to obtain the target gain value matching the second distance.

The target gain value matching the second distance may be alternatively determined as follows. From multiple predetermined sound source distance ranges, a predetermined sound source distance range in which the second distance is located is determined. The multiple predetermined sound source distance ranges have a one-to-one correspondence with multiple predetermined gain values. The predetermined gain value corresponding to the predetermined sound source distance range in which the second distance is located is determined as the target gain value matching the second distance. For example, the multiple predetermined sound source distance ranges may include: a range shorter than or equal to 1 meter, a range from 1 meter to 2 meters, a range from 2 meters to 5 meters, and a range equal to or longer than 5 meters, and corresponding predetermined gain values may be 10, 12, 14, and 16, respectively.

The value taken for the input gain is related to the wear state. As shown in FIG. 6, which schematically illustrates a relationship between values of the input gain and wear states, according to the sequence of normal worn state, abnormal worn state and non-worn state, values of the input gain increase.

It is understandable that although the individual steps in the flowcharts involved in the embodiments as described above are shown sequentially as indicated by the arrows, these steps are not necessarily executed sequentially in the order indicated by the arrows. Unless expressly stated herein, there is no strict order limitation on the execution of these steps, and these steps may be executed in other orders. Moreover, at least a portion of the steps in the flowchart involved in the embodiments as described above may include multiple sub-steps or multiple phases, which are not necessarily to be executed simultaneously, but may be executed at different time. In addition, the order in which these sub-steps or phases are executed is not necessarily sequential, but may be performed in turn or alternately with at least a portion of the other steps or at least a portion of the sub-steps or phases in the other steps.

Based on the same inventive concept, a gain management device for a telephone headset is further provided according to an embodiment of the present application, for implementing the above-mentioned gain management method for the telephone headset. The scheme for solving technical problem provided by the device is similar to that recited in the above-mentioned method, so specific limitations in one or more embodiments directed to the gain management device for the telephone headset provided below can be referred to limitations for the above-mentioned gain management method for the telephone headset, which are not repeated herein.

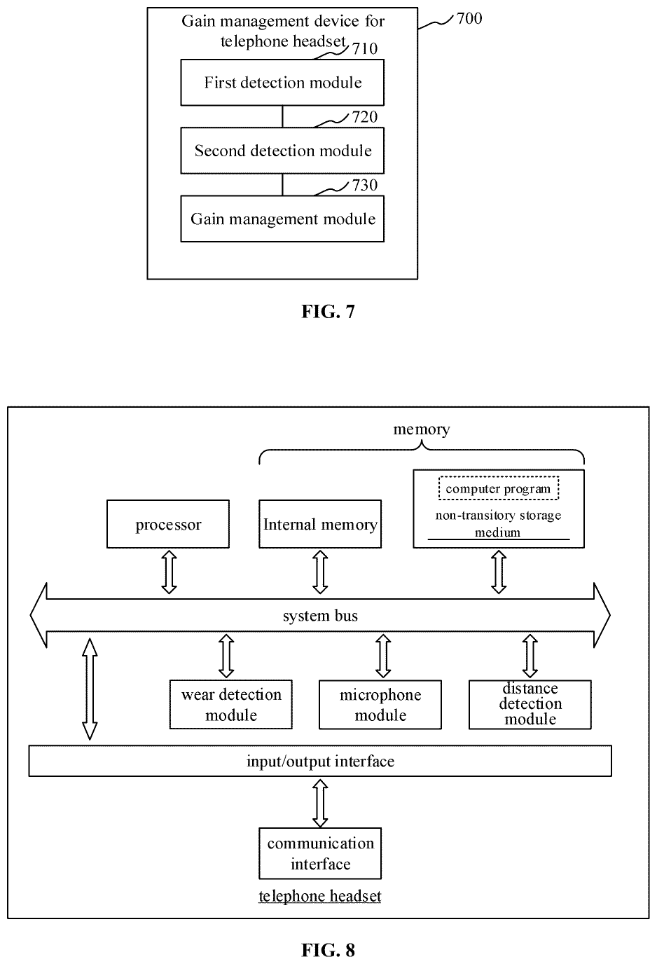

As shown in FIG. 7, a gain management device 700 for a telephone headset is provided according to an exemplary embodiment. The gain management device 700 includes: a first detection module 710, a second detection module 720, and a gain management module 730.

The first detection module 710 is configured to detect a wear state of a headset body of the telephone headset. The headset body is connected to a microphone boom of the telephone headset. A microphone module is arranged in the microphone boom.

The second detection module 720 is configured to detect a first distance from the microphone boom to the head of a human wearing the headset body in a case that the wear state of the headset body is a worn state.

The gain management module 730 is configured to: maintain an input gain of the microphone module at a standard gain value in a case that the first distance is within a pre-configured standard distance range, and adjust the input gain to a first gain value in a case that the first distance is beyond the standard distance range. The first gain value is greater than the standard gain value.

According to an exemplary embodiment, the gain management module 730 is further configured to: detect a second distance from a sound source in the environment to a microphone boom in a case that the wear state of the headset body is a non-worn state, determine a target gain value matching the second distance, and adjust the input gain to the target gain value.

In an exemplary embodiment, the microphone module includes a microphone array and a main microphone. The input gain of the microphone module is an input gain of the main microphone. The input gain is utilized to adjust the intensity of a sound received by the main microphone. The gain management module 730 is further configured to: receive a sound from the environment by each of multiple microphones included in the microphone array, and determine the second distance from the sound source to the microphone boom based on differences in time when every two of the multiple microphones receive the sound.

According to an exemplary embodiment, the gain management module 730 is further configured to: obtain a value taken for the second distance and a pre-configured standard sound source distance value, and determine the standard gain value as the target gain value matching the second distance in a case that the value taken for the second distance is not greater than the standard sound source distance value.

In an exemplary embodiment, the gain management module 730 is further configured to: in a case that the value taken for the second distance is greater than the standard sound source distance value, determine a sound pressure level (SPL) change amount of the value taken for the second distance with respect to the standard sound source distance value, the SPL change amount represents the degree of change in the SPL of the sound received by the microphone module when the value of the second distance is changed from the standard sound source distance value to the value taken for the second distance; determine a gain change amount matching the SPL change amount; and increase the standard gain value according to the gain change amount to obtain the target gain value matching the second distance.

According to an exemplary embodiment, the gain management module 730 is further configured to: detect a frequency of the sound received by the microphone module in the case that the first distance is beyond the standard distance range, and adjust the input gain to the first gain value in a case that the frequency is within a first frequency range.

The various modules in the above-mentioned gain management device for the telephone headset may be realized in whole or in part by software, hardware, and combinations thereof. Each of the above-mentioned modules may be embedded in or independent of a processor in the telephone headset in hardware form, or may be stored in a memory in the telephone headset in software form, so as to be invoked by the processor to perform an operation corresponding to each of the above-mentioned modules.

According to an exemplary embodiment, a telephone headset is provided. The telephone headset includes a headset body and a microphone boom, and an internal structure diagram of the telephone headset may be referred to FIG. 8. The telephone headset includes a wear detection module, a processor, a memory, an Input/Output (abbreviated as I/O) interface, and a communication interface disposed in the headset body, and a distance detection module and a microphone module disposed in the microphone boom. The wear detection module, the distance detection module, the microphone module, the processor, the memory, and the I/O interface are connected via a system bus. The communication interface is connected to the system bus via the I/O interface. The wear detection module of the telephone headset is configured to detect a wear state of the headset body. The distance detection module of the telephone headset is configured to detect a first distance from the microphone boom of the telephone headset to the head of a human wearing the headset body. The microphone module of the telephone headset is configured to receive a sound from an environment in which the telephone headset is located and process the sound. The processor of the telephone headset is configured to provide computing and control capabilities. The memory of the telephone headset includes a non-transitory storage medium and an internal memory. The non-transitory storage medium stores a computer program. The internal memory provides an environment for the operation of the computer program in the non-transitory storage medium. The I/O interface of the telephone headset is configured to exchange information between the processor and an external device. The communication interface of the telephone headset is configured to communicate with an external terminal via a network. The computer program, when executed by the processor, implements a gain management method for the telephone headset.

It is understandable by those skilled in the art that the structure illustrated in FIG. 8, which is only a block diagram of a portion of the structure related to the solution of the present application, does not constitute a limitation of the telephone headset according to the present application. The specific telephone headset may include more or fewer components than shown in FIG. 8, or certain components can be combined, or may have a different arrangement of components.

According to an embodiment, a computer-readable storage medium is provided, having stored thereon a computer program. The computer program, when executed by a processor, implements the steps of the method according to any foregoing embodiment.

According to an embodiment, a computer program product is provided. The computer program product includes a computer program that, when executed by a processor, implements the steps of the method according to any foregoing embodiment.

A person of ordinary skill in the art may understand that all or part of the processes in the methods of the above embodiments can be accomplished by a computer program to instruct the relevant hardware, and the computer program may be stored in a non-transitory computer-readable storage medium. The computer program, when executed, may include processes of the respective methods according to the foregoing embodiments. The memory, database, or other medium used in the embodiments provided by this application may include at least one of a non-transitory memory and a transitory memory. The non-transitory memory may include Read-Only Memory (ROM), magnetic tape, floppy disk, flash memory, optical memory, high-density embedded non-transitory memory, Resistive Random Access Memory (ReRAM), Magnetoresistive Random Access Memory (MRAM), Ferroelectric Random Access Memory (FRAM), Phase Change Memory (PCM), Graphene Memory and so on. The transitory memory may include a Random Access Memory (RAM) or an external cache, and the like. As an illustration and not as a limitation, the RAM may be in various forms, such as Static Random Access Memory (SRAM) or Dynamic Random Access Memory (DRAM), and the like. The database involved in the embodiments provided in the present application may include at least one of a relational database and a non-relational database. The non-relational database may include a blockchain-based distributed database, etc., which is not limited herein. The processor involved in the embodiments provided in the present application may be a general-purpose processor, a central processing unit, a graphics processing unit, a digital signal processor, a programmable logic, a data processing logic based on quantum computing, an artificial intelligence (AI) processor, and the like, which is not limited herein.

The various technical features of the above embodiments may be combined arbitrarily. Possible combinations of the various technical features of the above embodiments are not enumerated for sake of conciseness. However, as long as there is no contradiction in the combinations of these technical features, they should be considered as falling within the scope of protection of the present application.

The above-described embodiments are merely several embodiments of the present application. These embodiments are described in a specific and detailed manner, but they shall not be construed as limitations to the scope of protection of the present application. It should be pointed out that for a person of ordinary skill in the art, various deformations and improvements can be made without departing from the concept of the present application, which all fall within the scope of protection of the present application. Therefore, the scope of protection of the present application shall be subject to the attached claims.

What is claimed is:

1. A gain management method for a telephone headset, comprising:
detecting a wear state of a headset body of the telephone headset, wherein the headset body is connected to a microphone boom of the telephone headset, and a microphone module is arranged in the microphone boom;
detecting a first distance from the microphone boom to a head of a human wearing the headset body in a case that the wear state of the headset body is a worn state;
maintaining an input gain of the microphone module at a standard gain value in a case that the first distance is within a pre-configured standard distance range; and
adjusting the input gain to a first gain value in a case that the first distance is beyond the standard distance range, the first gain value being greater than the standard gain value.

2. The gain management method according to claim 1, further comprising:
detecting a second distance from a sound source in an environment to the microphone boom in a case that the wear state of the headset body is a non-worn state;
determining a target gain value matching the second distance, and adjusting the input gain to the target gain value.

3. The gain management method according to claim 2, wherein the microphone module comprises a microphone array and a main microphone, the input gain of the microphone module is an input gain of the main microphone, the input gain is utilized to adjust an intensity of a sound received by the main microphone, and the main microphone is utilized to receive the sound and output the sound after sound processing;
wherein detecting the second distance from the sound source in the environment to the microphone boom comprises:
receiving a sound from the environment by each of a plurality of microphones comprised in the microphone array; and
determining the second distance from the sound source to the microphone boom based on differences in time when every two of the plurality of microphones receive the sound.

4. The gain management method according to claim 2, wherein determining the target gain value matching the second distance comprises:
obtaining a value taken for the second distance, and a pre-configured standard sound source distance value; and
determining the standard gain value as the target gain value matching the second distance in a case that the value taken for the second distance is not greater than the standard sound source distance value.

5. The gain management method according to claim 4, wherein determining the target gain value matching the second distance comprises:
determining a sound pressure level (SPL) change amount of the value taken for the second distance with respect to the standard sound source distance value in a case that the value taken for the second distance is greater than the standard sound source distance value, the SPL change amount representing a degree of change in the SPL of the sound received by the microphone module when a value of the second distance is changed from the standard sound source distance value to the value taken for the second distance; and
determining a gain change amount matching the SPL change amount; and increasing the standard gain value according to the gain change amount to obtain the target gain value matching the second distance.

6. The gain management method according to claim 1, wherein adjusting the input gain to the first gain value in the case that the first distance is beyond the standard distance range comprises:
detecting a frequency of the sound received by the microphone module in the case that the first distance is beyond the standard distance range; and
adjusting the input gain to the first gain value in a case that the frequency is within a first frequency range.

7. A gain management device for a telephone headset, comprising:
a first detection module, configured to detect a wear state of a headset body of the telephone headset, wherein the headset body is connected to a microphone boom of the telephone headset, and a microphone module is arranged in the microphone boom;
a second detection module, configured to detect a first distance from the microphone boom to a head of a human wearing the headset body in a case that the wear state of the headset body is a worn state; and
a gain management module, configured to: maintain an input gain of the microphone module at a standard gain value in a case that the first distance is within a pre-configured standard distance range; and adjust the input gain to a first gain value in a case that the first distance is beyond the standard distance range, the first gain value being greater than the standard gain value.

8. A telephone headset, comprising a headset body and a microphone boom, further comprising a wear detection module, a memory and a processor provided in the headset body, and a distance detection module and a microphone module provided in the microphone boom, wherein the memory stores a computer program;
wherein the wear detection module is configured to detect a wear state of the headset body, the distance detection module is configured to detect a first distance from the microphone boom to a head of a human wearing the headset body, the microphone module is configured to receive a sound from an environment in which the telephone headset is located and process the sound, and the processor, when executing the computer program, perform steps of the gain management method according to claim 1.

9. A computer-readable storage medium, which stores a computer program thereon, wherein the computer program, when executed by a processor, implements steps of the gain management method according to claim 1.
